(19) United States
(12) Patent Application Publication
(10) Pub. No.: US 2026/0302955 A1
(43) Pub. Date: Oct. 1, 2026

(54) MULTIPHASE POWER CONVERTER CONTROL

(71) Applicant: Texas Instruments Incorporated, Dallas, TX (US)

(72) Inventor: Longqi Li, MAOMING CITY (CN)

(21) Appl. No.: 19/094,390

(22) Filed: Mar. 28, 2025

(51) Int. Cl. H02M 3/335; H02M 3/00

(52) U.S. Cl. CPC H02M 3/33569; H02M 3/01

(57) ABSTRACT

In described examples, a device includes first and second phase transformers, first and second phase primary side circuits, first and second secondary side circuits, a delay circuit, and a controller. The first phase primary side circuit is coupled to the first phase transformer's primary winding. The first phase secondary side circuit is coupled to the first phase transformer's secondary winding. The second phase primary side circuit is coupled to the second phase transformer's primary winding. The second phase secondary side circuit is coupled to the second phase transformer's secondary winding. The controller is coupled to the first and second phase primary side circuits and the delay circuit. The controller controls the first phase primary side circuit responsive to a switching cycle duration, determines a phase delay responsive to the switching cycle duration, and controls the second phase circuit, using the delay circuit, responsive to the phase delay.

### TECHNICAL FIELD

This application relates generally to pulse width modulation (PWM) control of power converters, and more particularly to PWM control of multiple phase power converters.

### BACKGROUND

In some examples, a PWM signal is used to control a switched device such as a power converter. Resonant converters are variable switching frequency direct current-direct current (DC-DC) converters. Example applications for resonant converters include server, telecom, automotive, industrial, and other power supply contexts.

Some applications, such as certain high-power applications, require use of multiphase interleaved converters. In some examples, multiphase converters use multiple primary side circuits coupled to corresponding primary windings. Control signals of the different primary side circuits are phase-shifted with respect to each other. In some example interleaved converters, there is a fixed-phase relationship between the different phases under the operating frequency (or frequencies). Prolonged departure from the fixed-phase relationship may cause converter inefficiency or instability.

### SUMMARY

In described examples, a device includes first and second phase transformers, first and second phase primary side circuits, first and second secondary side circuits, a delay circuit, and a controller. The first phase primary side circuit is coupled to the first phase transformer's primary winding. The first phase secondary side circuit is coupled to the first phase transformer's secondary winding. The second phase primary side circuit is coupled to the second phase transformer's primary winding. The second phase secondary side circuit is coupled to the second phase transformer's secondary winding. The controller is coupled to the first and second phase primary side circuits and the delay circuit. The controller controls the first phase primary side circuit responsive to a switching cycle duration, determines a phase delay responsive to the switching cycle duration, and controls the second phase circuit, using the delay circuit, responsive to the phase delay.

In described examples, a device includes a counter circuit, a comparator, a first pulse-width modulation circuit, and a second pulse-width modulation circuit. The counter circuit is configured to provide a count value. The comparator is coupled to the counter circuit and configured to compare the count value to a threshold, and to provide a signal based on the comparison of the count value to the threshold. The first pulse-width modulation circuit is coupled to the comparator and configured to provide a first pulse-width modulation signal having a transition based on the count value satisfying the threshold. The second pulse-width modulation circuit is coupled to the comparator and the first pulse width modulation circuit. The second pulse-width modulation circuit includes a delay circuit configured to determine a delay value based on the count value when the count value satisfies the threshold. The second pulse-width modulation circuit is configured to provide a second pulse-width modulation signal having a transition based on the transition in the first pulse-width modulation signal and the delay value.

In described examples, a device includes first and second phase transformers, first and second phase primary side circuits, first and second secondary side circuits, a delay circuit, and a controller. The first phase primary side circuit is coupled to the first phase transformer's primary winding. The first phase secondary side circuit is coupled to the first phase transformer's secondary winding. The first phase primary side circuit includes a first inductor, a first capacitor, and first and second switches. The first inductor is coupled to the first terminal of the primary winding of the first phase transformer. The first terminal of the first capacitor is coupled to the second terminal of the primary winding of the first phase transformer. The first terminal of the second switch is coupled to the first switch and the first inductor, and the second terminal of the second switch is coupled to the second terminal of the first capacitor. The second phase primary side circuit is coupled to the second phase transformer's primary winding. The second phase secondary side circuit is coupled to the second phase transformer's secondary winding. The second phase primary side circuit includes a second inductor, a second capacitor, and third and fourth switches. The second inductor is coupled to the first terminal of the primary winding of the second phase transformer. The first terminal of the second capacitor is coupled to the second terminal of the primary winding of the second phase transformer. The first terminal of the fourth switch is coupled to the third switch and the second inductor, and the second terminal of the fourth switch is coupled to the second terminal of the second capacitor. The controller is coupled to the first and second phase primary side circuits and the delay circuit. The controller controls the first phase primary side circuit responsive to a switching cycle duration, determines a phase delay responsive to the switching cycle duration, and controls the second phase circuit, using the delay circuit, responsive to the phase delay.

### BRIEF DESCRIPTION OF THE DRAWINGS

FIG. 1 is a functional block and circuit diagram of an example power converter system.

FIG. 2 is a set of graphs of example signals corresponding to PWM control of the first primary side of the power converter system of FIG. 1.

FIG. 3 is a set of graphs of example signals of the power converter system of FIG. 1.

FIG. 4 is an example functional block diagram of the PWM module of FIG. 1.

FIGS. 5A and 5B are a set of graphs of example PWM control signals of the power converter system of FIG. 1.

FIG. 6 is a flow diagram for an example process for adjusting a delay to be applied to second phase PWM control signals for the power converter system of FIG. 1.

### DETAILED DESCRIPTION

Multiphase inductor-inductor-capacitor (LLC) converters are useful in a variety of applications, such as industrial and automotive applications. Multiphase converters include a first phase circuit connected to a primary winding of a first phase transformer, and a second phase circuit connected to a primary winding of a second phase transformer. Switches of the first phase circuit control application of energy to the primary winding of the first phase transformer to store magnetic energy in a magnetic core of the first phase transformer with a first polarity or a second polarity. Similarly, switches of the second phase circuit control application of energy to the primary winding of the second phase transformer to store magnetic energy in a magnetic core of the second phase transformer with a first polarity or a second polarity.

The second phase switches are controlled to open and close with a phase delay with respect to control of the first phase switches. This phase delay can be provided using a delay circuit that provides second phase control signals with a delay time responsive to a switching frequency of first phase primary side switches. Changes in this delay between sequential control events (such as control corresponding to a rising signal edge following a falling signal edge, or vice versa) can be capped by a maximum delay step to avoid departing too far from a designed duty cycle of the switches. In some examples, this helps to avoid system instability caused by deviation from the designed duty cycle, such as system instability responsive to a current imbalance between the phases.

For convention in this document, metal-oxide-semiconductor field-effect transistors (MOSFETS) are numbered as M[channel type][number], where the number increases for each differing transistor of a same channel type. Channel types include n-channel MOSFETS (NMOS) and p-channel MOSFETS (PMOS). The channel type for each transistor is only an example, and other examples may substitute another transistor of a different type for any illustrated transistor. Also, the same reference numbers or other reference designators are used in the drawings to designate features that are related structurally and/or functionally.

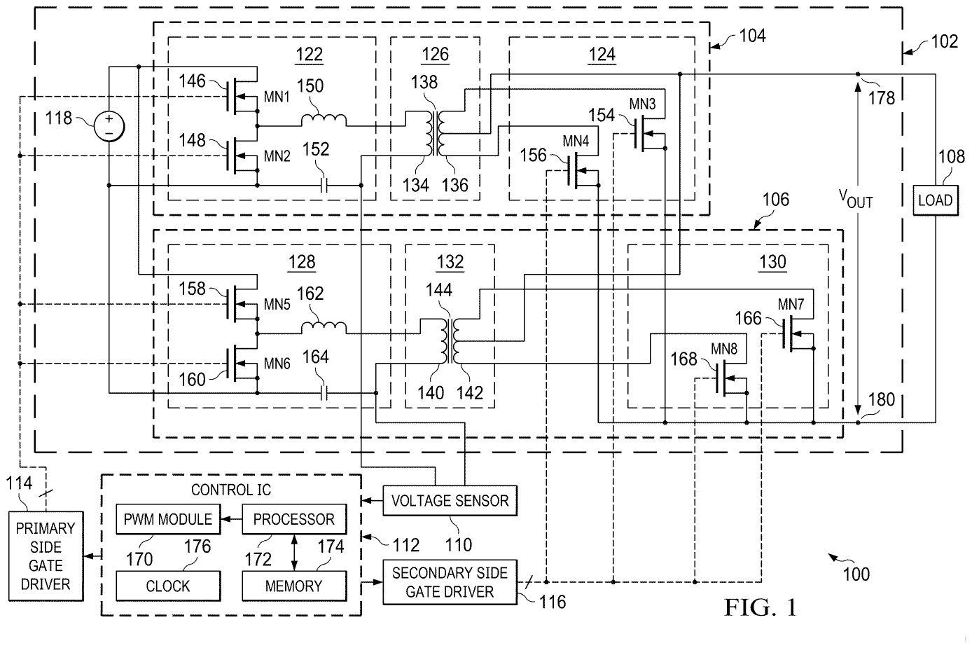

FIG. 1 is a functional block and circuit diagram of an example power converter system 100. The power converter system 100 includes a two phase LLC converter 102 that has a first phase circuit 104, a second phase circuit 106, a load 108, a voltage sensor 110, a control integrated circuit (IC) 112, a primary side gate driver circuit 114, a secondary side gate driver circuit 116, and a voltage source 118.

The first phase circuit 104 includes a first primary side 122, a first secondary side 124, and a first transformer 126. The second phase circuit 106 includes a second primary side 128, a second secondary side 130, and a second transformer 132. The first transformer 126 includes a first primary winding 134 coupled to the first primary side 122, a first secondary winding 136 coupled to the first secondary side 124, and a first isolation 138. The second transformer 132 includes a second primary winding 140 coupled to the second primary side 128, a second secondary winding 142 coupled to the second secondary side 130, and a second isolation 144.

The first primary side 122 includes a first n-channel MOSFET (MN1) 146, a second n-channel MOSFET (MN2) 148, a first inductor 150, and a first capacitor 152. The first secondary side 124 includes a third n-channel MOSFET (MN3) 154 and a fourth n-channel MOSFET (MN4) 156.

The second primary side 128 includes a fifth n-channel MOSFET (MN5) 158, a sixth n-channel MOSFET (MN6) 160, a second inductor 162, and a second capacitor 164. The second secondary side 130 includes a seventh n-channel MOSFET (MN7) 166 and an eighth n-channel MOSFET (MN8) 168. The first and second inductors 150 and 162 may be, for example, external inductors or leakage inductances of the first and second transformers 126 and 132 (respectively). MN1 146, MN2 148, MN5 158, and MN6 160 are collectively referred to as the primary side switches.

Together, the first inductor 150, a magnetizing inductance of the first primary winding 134, and the first capacitor 152 form a first resonant tank circuit. Together, the second inductor 162, a magnetizing inductance of the second primary winding 140, and the second capacitor 164 form a second resonant tank circuit. In accordance with the first and second resonant tank circuits, the two phase LLC converter 102 is referred to as a resonant power converter.

The control IC 112 includes a PWM module 170, a processor 172, a memory 174, and a clock circuit 176. In some examples, the processor 172 is a central processing unit (CPU), a digital signal processor (DSP), or a microcontroller unit (MCU). The memory 174 includes a memory circuit storing instructions for performing an interrupt service routine (ISR) or other background process (or other process) for controlling the PWM module 170. In some examples, the PWM control process is stored in a flash memory bank of the memory 174. In some examples, signals responsive to voltage measurements by the voltage sensor 110 are sampled by circuits of the control IC 112, such as the circuits of the processor 172. Sample values are processed by the processor 172 and/or stored by the memory 174.

On the primary side (first and second primary sides 122 and 128), a positive terminal of the voltage source 118 is connected to a drain of MN1 146 and a drain of MN5 158. A source of MN1 146 is connected to a drain of MN2 148 and a first terminal of the first inductor 150. A second terminal of the first inductor 150 is connected to a first terminal of the first primary winding 134. A second terminal of the first primary winding 134 is connected to a first terminal of the first capacitor 152 and a first input of the voltage sensor 110. A second terminal of the first capacitor 152 is connected to a source of MN2 148 and a negative terminal of the voltage source 118. Gates of MN1 146 and MN2 148 are connected to output(s) (such as respective separate, complementary outputs) of the primary side gate driver circuit 114.

A source of MN5 158 is connected to a first terminal of the second inductor 162 and a drain of MN6 160. A second terminal of the second inductor 162 is connected to a first terminal of the second primary winding 140. A second terminal of the second primary winding 140 is connected to a first terminal of the second capacitor 164 and a second input of the voltage sensor 110. A second terminal of the second capacitor 164 is connected to a source of MN6 160 and to the negative terminal of the voltage source 118. Gates of MN5 158 and MN6 160 are connected to an output (such as respective separate, complementary outputs) of the primary side gate driver circuit 114. MN1 146 and MN5 158, which are both connected to the positive terminal of the voltage source 118, are referred to herein as high side switches. MN2 148 and MN6 160, which are both connected to the negative terminal of the voltage source 118, are referred to herein as low side switches.

MN1 146, MN2 148, MN5 158, and MN6 160 serve a switching function for the LLC converter 102. MN1 146 and MN2 148 control current flow through the first primary coil 134, and MN5 158 and MN6 160 control current flow through the second primary coil 140. Accordingly, MN1 146, MN2 148, MN5 158, and MN6 160 control transfer of energy from the primary coils 134 and 140 to respective (first and second) secondary coils 136 and 142.

On the secondary side (first and second secondary sides 124 and 130), center taps of the first secondary winding 136 and the second secondary winding 142 are connected to a first output terminal 178. The first output terminal 178 is connected to a first terminal of the load 108. A first terminal of the first secondary winding 136 is connected to a drain of MN3 154. A second terminal of the first secondary winding 136 is connected to a drain of MN4 156. Sources of MN3 154 and MN4 156 are connected to a second output terminal 180. The second output terminal 180 is connected to a second terminal of the load 108.

A first terminal of the second secondary winding 142 is connected to a drain of MN7 166. A second terminal of the second secondary winding 142 is connected to a drain of MN8 168. Sources of MN7 166 and MN8 are connected to the second output terminal 180. Gates of MN3 154, MN4 156, MN7 166, and MN8 168 are connected to output(s) (such as respective separate, complementary outputs) of the secondary side gate driver circuit 116. Accordingly, in an example, gates of MN3 154 and MN4 156 are connected to a first pair of complementary outputs of the secondary side gate driver circuit 116, and gates of MN7 166 and MN8 168 are connected to a second pair of complementary outputs of the secondary side gate driver circuit 116. A voltage between the first output terminal 178 and the second output terminal 180 corresponds to an output voltage of the LLC converter 102, accordingly, a voltage across the load 108.

An output of the voltage sensor 110 is connected to an input of the control IC 112. The processor 172 is connected to communicate with the memory 174. An output of the processor 172 is connected to an input of the PWM module 170. A first output of the control IC 112 is connected to an input of the primary side gate driver circuit 114, and a second output of the control IC 112 is connected to an input of the secondary side gate driver circuit 116.

The processor 172 controls the PWM module 170 responsive to instructions in the memory 174 (such as the ISR described above) and responsive to feedback signals provided by the voltage sensor 110. The PWM module 170 controls the primary side gate driver 114 and the secondary side gate driver 116. The primary side gate driver 114 controls MN1 146, MN2 148, MN5 158, and MN6 160 to open and close. MN1 146 and MN2 148 are controlled to enable energy transfer across the first transformer 126 from the first primary side 122 to the first secondary side 124. MN5 158 and MN6 160 are controlled to enable energy transfer across the second transformer 132 from the second primary side 128 to the second secondary side 130.

The secondary side gate driver 116 controls MN3 154 and MN4 156 to rectify current induced in the first secondary winding 136 according to energy transferred from the first primary winding 134. Accordingly, MN3 154 and MN4 156 are controlled to rectify current through the first secondary winding 136. The secondary side gate driver 116 controls MN7 166 and MN8 168 to rectify current induced in the second secondary winding 142 according to energy transferred from the second primary winding 140. Accordingly, MN7 166 and MN8 168 are controlled to rectify current through the second secondary winding 142.

When a high side switch (MN1 146 or MN5 158) is on and the corresponding low side switch (MN2 148 or MN6 160) is off, current flowing from the positive terminal of the voltage source 118, through the corresponding inductor 150 or 162, and through the corresponding primary winding 134 or 140 increases. While current flows through the primary winding 134 or 140 towards the corresponding capacitor 152 or 164, the capacitor 152 or 164 charges and the primary winding 134 or 140 generates a magnetic flux that causes a corresponding magnetic core (not shown) to store magnetic energy with a first polarity.

When the high side switch (MN1 146 or MN5 158) is off and the corresponding low side switch (MN2 148 or MN6 160) is on, current flowing from the corresponding capacitor 152 or 164, through the corresponding primary winding 134 or 140, through the corresponding inductor 150 or 162, towards the negative terminal of the voltage source 118 increases. While current flows through the primary winding 134 or 140 towards the negative terminal of the voltage source 118, the capacitor 152 or 164 discharges and the primary winding 134 or 140 generates a magnetic flux that causes the corresponding magnetic core to store magnetic energy with a second polarity. Magnetic flux generated by the primary winding 134 or 140 induces current in the corresponding secondary winding 136 or 142 that is rectified by MN3 154 and MN4 156 or by MN7 166 and MN8 168, respectively. The rectified current provides direct current (DC) power to the load 108.

In some resonant power converters, as output current demand (current demand of the load 108) falls, a switching frequency of transistors controlling power transfer is increased to reduce power output. In the LLC converter 102, this corresponds to increasing a switching frequency of the high side and low side switches 146, 148, 158, and 160.

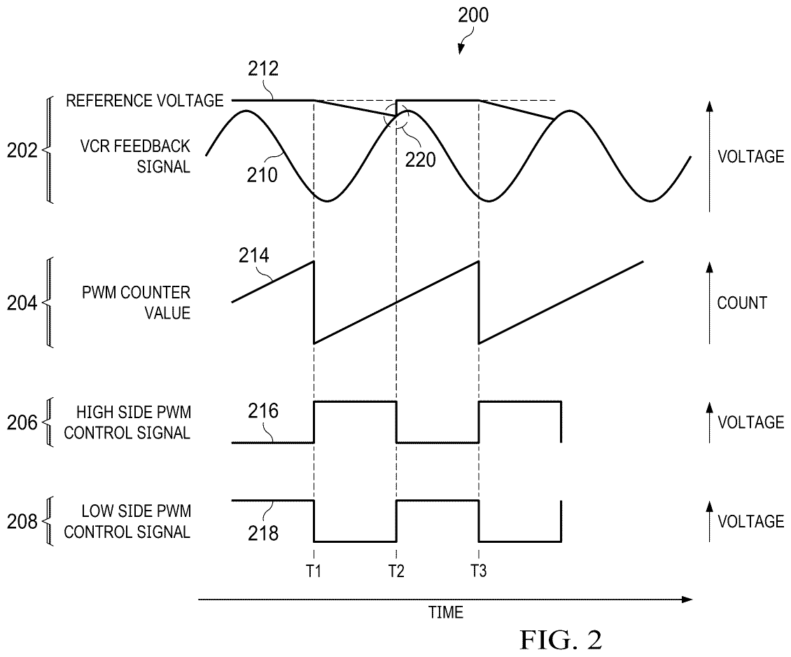

FIG. 2 is a set of graphs 200 of example signals corresponding to PWM control of the first primary side 122 of the power converter system 100 of FIG. 1. The graphs 200 include a first graph 202, a second graph 204, a third graph 206, and a fourth graph 208. In some examples, the graphs 200 describe behavior of the first phase circuit 104 of the power converter system 100. Horizontal axes of each of the graphs 202, 204, 206, and 208 indicate time. Vertical axes of the first, third, and fourth graphs 202, 206, and 208 indicate voltage. A vertical axis of the second graph 204 indicates a count. FIG. 2 illustrates example signals for current mode control of an LLC converter. Note that methods and structures disclosed herein are applicable to voltage mode control, alternative approaches to current mode control, and other types of multiphase converters.

A first graph 202 includes a resonance capacitor voltage (VCR) feedback signal curve 210 and a reference voltage curve 212. The second graph 204 includes a PWM counter value 214, which tracks a counter value generated by a PWM counter. In some examples, the PWM counter is included in the PWM module 170. The third graph 206 includes a high side PWM control signal 216 used to control high side switches MN1 146 and MN5 158. The fourth graph 208 includes a low side PWM control signal 218 used to control low side switches MN2 148 and MN6 160. For clarity, the graphs 202, 204, 206, and 208 do not illustrate periods when MN1 146, MN2 148, MN5 158, and MN6 160 are all open to prevent shoot-through (also referred to as dead times or dead bands).

Recall that the first capacitor 152 participates in the resonance of the first phase circuit 104. The VCR feedback signal curve 210 is responsive to the voltage measured by the voltage sensor 110, accordingly, is responsive to the voltage across the first capacitor 152. Specifically, the VCR feedback signal curve 210 is positive in a direction looking from the first primary winding 134 to the negative terminal of the voltage source 118.

Prior to time T1, the reference voltage curve 212 is constant and the PWM counter value 214 is increasing. At T1, the VCR feedback signal 210 has a negative slope and the PWM counter value 214 equals a first value (PWMcount_{PRD}) corresponding to the duration of a switching period that sequentially preceded T1. Accordingly, the PWM counter value 214 equals a PWMcount_{PRD} value at the end of a switching period corresponding to that PWMcount_{PRD} value.

Responsive to a clock edge following T1 (such as a rising edge or a falling edge), the PWM counter value 214 is reset to zero (or other base line value), the high side PWM signal 216 transitions to a first voltage (such as a high voltage, as illustrated in FIG. 2), and the low side PWM signal 218 transitions to a second voltage with an opposite logic value from the high voltage (such as a low voltage, as illustrated). Also, the reference voltage 212 is allowed to decrease at a designed rate, such as a rate responsive to a capacitor in a resistor-capacitor (RC) circuit (not shown) charging or discharging.

From the clock cycle following T1 to T2, the PWM module 170 provides the high side PWM signal 216 with the high voltage to the primary side gate driver 114 to control MN1 146 to close. The PWM module 170 provides the low side PWM signal 218 with the low voltage to the primary side gate driver 114 to control MN2 148 to open. This causes an increase in current flow in a direction from the positive terminal of the voltage source 118, through MN1 146, via the first primary winding 134, to the first capacitor 152, so that a slope of the VCR feedback signal curve 210 increases from the clock cycle after T1 to T2.

T2 corresponds to the decreasing reference voltage curve 212 intersecting 220 the VCR feedback signal curve 210. At T2, the PWM counter value 214 equals a second value (PWMcount_{TRNS}) corresponding to a half switching period. Accordingly, at T2, the PWM high side signal 216 transitions to the low voltage, the PWM low side signal 218 transitions to the high voltage, and PWMcount_{TRNS} is stored in the memory 174. Also, the reference voltage 212 is reset to and held at the constant voltage it held prior to T1.

From T2 to T3, the PWM module 170 provides the high side PWM signal 216 with the low voltage to the primary side gate driver 114 to control MN1 146 to open. The PWM module 170 provides the low side PWM signal 218 with the high voltage to the primary side gate driver 114 to control MN2 148 to close. This causes an increase in current flow in a direction from the first capacitor 152, via the first primary winding 134, through MN2 148, to the negative terminal of the voltage source 118, so that a slope of the VCR feedback signal curve 210 decreases from T2 to T3.

T3 corresponds to the end of the switching period that started at T1. At T3, the PWM counter value 214 equals two times PWMcount_{TRNS}, accordingly, two times the PWM counter value 214 at T2 (the half switching period time). This counter value corresponds to the end of the switching period represented by the duration from T1 to T3. Accordingly, two times PWMcount_{TRNS} equals a value of PWMcount_{PRD} that corresponds to the end of the switching period that began at T1. Note that PWMcount_{TRNS} and PWMcount_{PRD} can change from a switching period to a sequentially next switching period. In some examples, changes in the VCR feedback signal 210 cause the control IC 112 to control a change in the switching frequency of the primary switches MN1 146, MN2 148, MN5 158, and/or MN6 160.

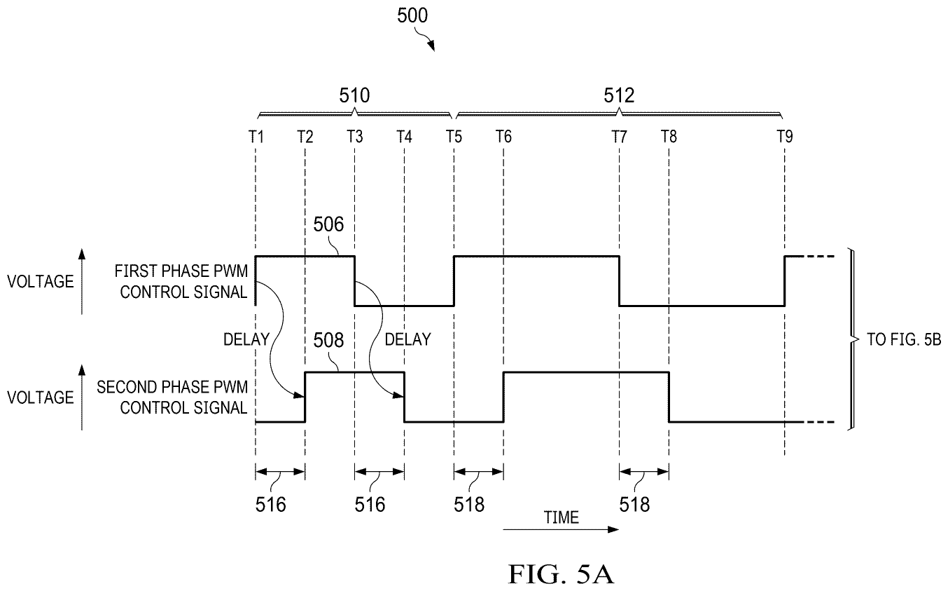

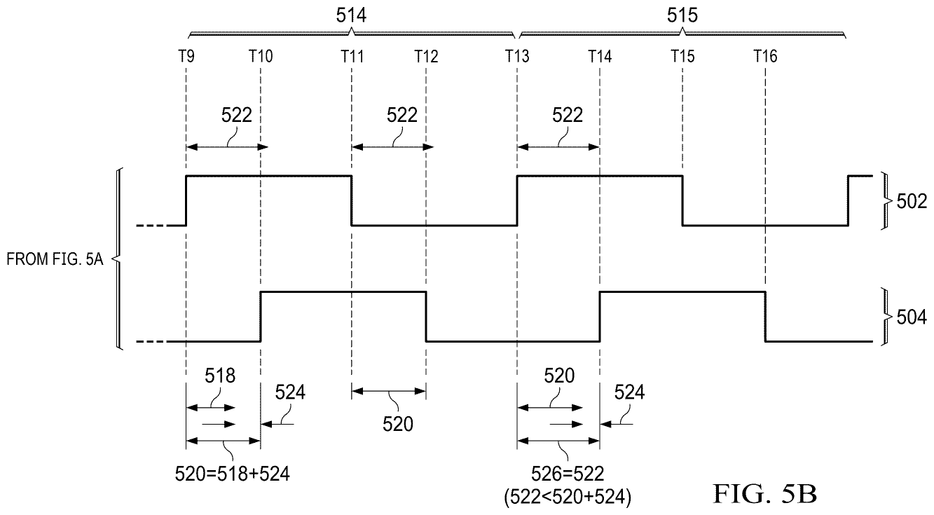

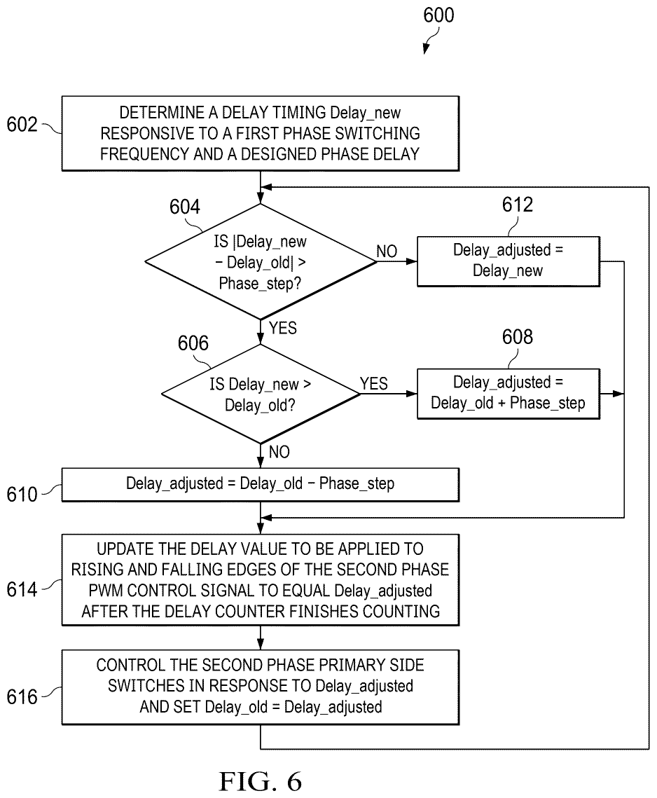

The low side PWM signal 218 from T2 to T3 is a copy of the high side PWM signal 216 from T1 to T2. The high side PWM signal 216 from T2 to T3 is a copy of the low side PWM signal 218 from T1 to T2. Signal behavior of the second phase circuit 106 of the power converter system 100 is further described with respect to FIGS. 5 and 6.

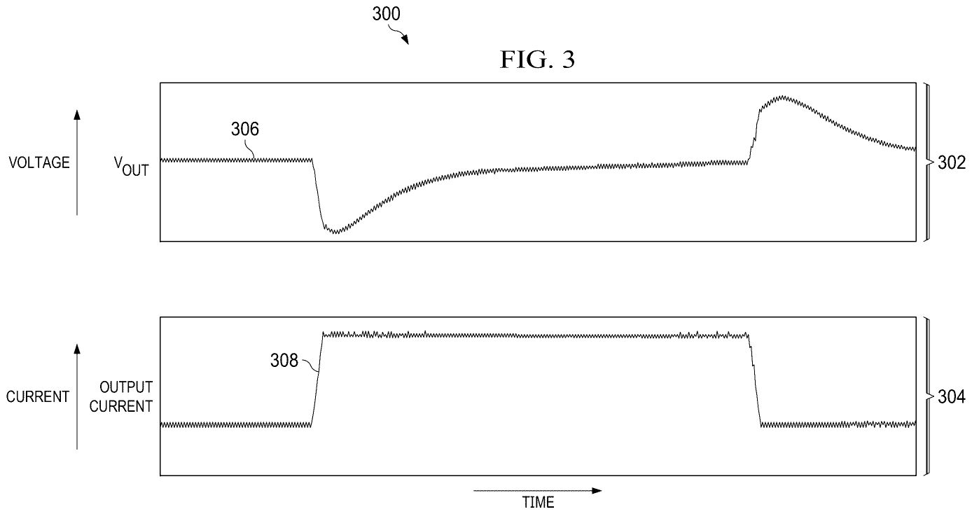

FIG. 3 is a set of graphs 300 of example signals of the power converter system 100 of FIG. 1. The graphs 300 include a first graph 302 and a second graph 304. A horizontal axis of each of the graphs 302 and 304 indicates time. A vertical axis of the first graph 302 indicates voltage. A vertical axis of the second graph 304 indicates current. The first graph 302 includes a V_{OUT} curve 306 corresponding to V_{OUT}, accordingly, voltage across the load 108. The second graph 304 includes an output current curve 308 corresponding to current through the load 108.

In some examples, a power converter system 100 regulates V_{OUT} using frequency modulation. Accordingly, after a load decreases or increases, the control IC 112 (or other control circuit) adjusts a switching frequency of the primary side switches responsive to feedback information, such as the VCR feedback signal 210 provided by the voltage sensor 110. In some examples, adjusting the switching frequency of the primary side switches adjusts power transferred from the primary sides 122 and 128 to respective secondary sides 124 and 130, which over time adjusts V_{OUT}.

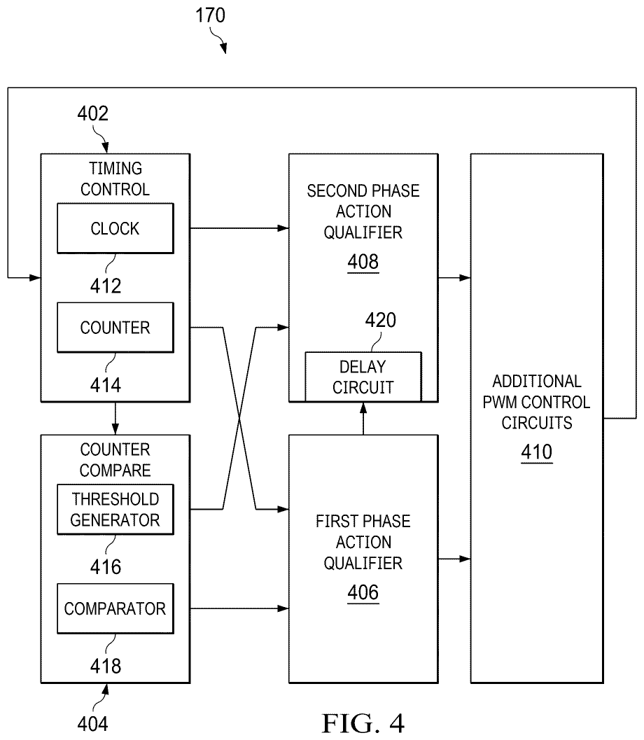

FIG. 4 is an example functional block diagram of the PWM module 170. The PWM module 170 includes a timing control circuit 402, a counter compare circuit 404, a first phase action qualifier (AQ) 406, a second phase AQ 408, and additional PWM control circuits 410. The primary and secondary AQs 406 and 408 determine rising and falling edge timing for respective PWM control signals. Accordingly, the primary AQ 406 determines edge timing for PWM control signals corresponding to MN1 146 and MN2 148, and the secondary AQ 408 determines edge timing for PWM control signals corresponding to MN5 158 and MN6 160.

The timing control circuit 402 includes a clock circuit 412 that generates a clock signal, and one or more counters 414 that provide respective counts responsive to the clock signal. The counter compare circuit 404 includes a threshold generator 416 and a comparator 418. The threshold generator 416 generates one or more threshold signals, such as threshold voltages, threshold currents, or threshold counts. The comparator 418 compares signals received from the timing control circuit 402 to corresponding thresholds. The second phase AQ 408 includes a delay circuit 420. The delay circuit 420 determines a delay of a second phase PWM control signal responsive to a first phase PWM control signal (such as the high side PWM control signal 216), as further described below and with respect to FIGS. 5 and 6. In some examples, the additional PWM control circuits 410 include a dead band generator, a PWM chopper, a trip zone circuit, a digital compare circuit, or an input/output circuit.

In some examples, the delay provided by the delay circuit 420 is determined so that the second phase PWM control signal has a phase delay with respect to the first phase PWM control signal of 90° (π/2 radians). In some examples, the delay circuit 420 provides a delay responsive to a delay used for a sequentially previous switching cycle. In some examples, the delay circuit 420 provides this delay adjusted (increased or reduced) so that the phase delay with respect to the first phase PWM control signal is closer to 90°. In some examples, this adjustment is made responsive to a change in a switching frequency controlled by the first phase PWM control signal. In some examples, the delay circuit 420 adjusts (adds to or subtracts from) the delay by the lesser of (1) a delay step that sets the phase delay equal the 90°, or (2) a designed delay step. The designed delay step can be described as a maximum delay adjustment. In some examples, the designed delay step is set in hardware, or is stored (such as programmed) in the memory 174 or other memory. In some examples, the delay step can be programmed in response to software, such as a firmware update.

A first output of the timing control circuit 402 is connected to an input of the counter compare circuit 404. A second output of the timing control circuit 402 is connected to a first input of the first phase AQ 406. A third output of the timing control circuit 402 is connected to a first input of the second phase AQ 408. In some examples, outputs of the timing control circuit 402 provide the clock signal and/or one or more counter values, such as the PWM counter value 214. A first output of the counter compare circuit 404 is connected to a second input of the first phase AQ 406. A second output of the counter compare circuit 404 is connected to a second input of the second phase AQ 408. In some examples, outputs of the counter compare circuit 404 provide indicators used by an AQ 408 to determine timing of signal events, such as rising or falling edges of a PWM control signal 216, 218, 506, or 508 (FIG. 5).

A first output of the first phase AQ 406 is connected to a first input of the additional PWM control circuits 410. A second output of the first phase AQ 406 is connected to a third input of the second phase AQ 408, and provides first phase PWM control signals 216 and/or 218. In an example, second phase PWM control signals are generated responsive to these control signals 216 and/or 218 and the delay circuit 420. An output of the second phase AQ 408 is connected to a second input of the additional PWM control circuits 410. In some examples, output from an AQ 406 or 408 to the additional PWM control circuits 410 provides PWM control signals 216, 218, 506, or 508 to be additionally shaped prior to being provided to a gate driver 114 or 116 or as feedback signals. An output of the additional PWM control circuits 410 is connected to an input of the timing control circuit 402.

FIGS. 5A and 5B are a set of graphs 500 of example PWM control signals of the power converter system 100 of FIG. 1. FIG. 5B shows a continuation of the graphs of FIG. 5A. The graphs 500 include a first graph 502 and a second graph 504. Vertical axes of the first and second graphs 502 and 504 indicate voltage. Horizontal axes of the first and second graphs 502 and 504 indicate time. The first graph 502 includes a first phase PWM control signal curve 506, such as a high side first phase PWM control signal 216. The second graph 504 includes a second phase PWM control signal curve 508 that controls a second phase primary switch (such as MN5 158 or MN6 160). This second phase primary switch corresponds to a first phase primary switch (such as MN1 146 or MN2 148, respectively) controlled by the first phase PWM control signal 506.

The graphs 500 span a time period corresponding to multiple switching cycles of the first phase PWM control signal 506, specifically, a first switching cycle 510, a second switching cycle 512, a third switching cycle 514, and a fourth switching cycle 515. The first switching cycle 510 corresponds to a steady state, or constant load 108, behavior of the power converter system 100. A first phase switching frequency changes in the second switching cycle 512, and remains constant through the second, third, and fourth switching cycles 512, 514, and 514. Primary side control of the power converter system 100 returns to steady state behavior in the fourth switching cycle 515.

In some examples, a first phase switching frequency change is triggered by a change in the load 108, in the input voltage, or in a controlled output voltage. Accordingly, in the steady state, the switching frequency controlled by the first phase PWM control signal 506 is approximately constant from one switching cycle to a sequentially next switching cycle. Also, responsive to the first switching cycle 510, delay provided by the delay circuit 420 to generate the second phase PWM control signal 508 responsive to the first phase PWM control signal 506 is approximately constant.

At T1, the first phase PWM control signal 506 has a rising edge and the second phase PWM control signal 508 has a low voltage, such as a zero voltage to control a corresponding primary switch to be open (deactivated). From T1 to T3, the first phase PWM control signal 506 has a high voltage, such as a voltage to control a corresponding primary switch to be closed (activated). At T2, the second phase PWM control signal 508 has a rising edge responsive to the T1 rising edge of the first phase PWM control signal 506 and a first delay 516 provided by the delay circuit 420. The first delay 516 corresponds to a quarter switching period of a sequentially previous switching cycle of the first phase PWM control signal 506. This delay duration corresponds to the count PWMcount_{PRD}/4, which equals (PWMcount_{TRNS}/2, as described with respect to FIG. 2. The second phase PWM control signal 508 has the high voltage from T2 to T4.

At T3, the first phase PWM control signal 506 has a falling edge. At T4, the second phase PWM control signal 508 has a falling edge responsive to the T3 falling edge of the first phase PWM control signal 506 and to the first delay 516. Herein, updating a delay refers to storing a delay count corresponding to the delay in a register (e.g., a register of delay circuit 420) used by the second phase AQ 408 to apply the delay to the second phase PWM control signal 508. In some examples, as further described with respect to FIG. 6, delay is not updated while a delay counter is counting. In some examples, this enables or ensures an on time controlled by the second phase PWM control signal 508 matches an on time controlled by the first phase PWM control signal 506. Accordingly, delay is determined and updated prior to T1 for the T2 rising edge, and delay is determined and updated between T2 and T3 for the T4 falling edge. In some examples, a second count (additional to PWM counter value 214) is maintained to facilitate updating delay after each half switching cycle.

The switching frequency of the first phase switches (MN1 148 and MN2 150) is different in the second switching cycle 512 from the first switching cycle 510. As described above, the control IC 112 may control a change in switching frequency of the primary switches responsive to a change in the VCR feedback signal 210. At T5, the first phase PWM control signal 506 has a rising edge and the second switching cycle 510 begins. At T6, the second phase PWM control signal 508 has a rising edge responsive to the T5 rising edge of the first phase PWM control signal 506 and to a second delay 518 provided by the delay circuit 420. The second delay 518 corresponds to a quarter switching period of the first switching cycle 510 (PWMcount_{TRNS}/2). Note that the duration of the second switching cycle 512 is not determined until T7, when the first phase PWM control signal 506 has a falling edge, corresponding to the reference voltage 212 and the VCR feedback signal 210 intersect 220.

At T7, the first phase PWM control signal 506 has a falling edge. At T8, the second phase PWM control signal 508 has a falling edge responsive to the T7 falling edge of the first phase PWM control signal 506 and to the second delay 518. In the graphs 500, the second switching cycle 512 corresponds to a lower switching frequency than the first switching cycle 510. The delay between corresponding rising or falling edges of the first and second phase PWM control signals 506 and 508 does not change in a second phase switching cycle corresponding to a primary phase switching cycle in which the switching frequency controlled by the first phase PWM control signal 506 changes. This is because an amount of delay to be applied to the second phase PWM control signal 508 is known after the first phase frequency has changed, accordingly, after a first phase switching period in which such change occurs has completed.

As described above, the switching frequency of the third switching cycle 514 equals the switching frequency of the second switching cycle 512. At T9, the first phase PWM control signal 506 has a rising edge and the third switching cycle 514 begins. At T10, the second phase PWM control signal 508 has a rising edge responsive to the T9 rising edge of the first phase PWM control signal 506 and to a third delay 520 provided by the delay circuit 420. Note that the third delay 520 is less than a quarter switching period 522 (from T7 to T8) of the second switching cycle 512 (PWMcount_{TRNS}/2). This is because PWMcount_{TRNS}/2 is greater than the second delay 518 plus the delay step 524. Accordingly, the third delay 520 is capped at and equals the second delay 518 plus the delay step 524.

If the second switching cycle 512 had a sufficiently higher switching frequency than the first switching cycle 510, then the third delay 520 would be greater than a quarter switching period 522 (from T7 to T8) of the second switching cycle 512. This would be caused by PWMcount_{TRNS}/2 being less than the second delay 518 minus the delay step 524. Accordingly, the third delay 520 would be capped at and would equal the second delay 518 minus the delay step 524.

At time T11, the first phase PWM control signal 506 has a falling edge. At time T12, the second phase PWM control signal 508 has a falling edge responsive to the T11 falling edge of the first phase PWM control signal 506 and to the third delay 520.

As described above, the switching frequency of the fourth switching cycle 515 equals the switching frequency of the second and third switching cycles 512 and 514. At T13, the first phase PWM control signal 506 has a rising edge and the fourth switching cycle 515 begins. At T14, the second phase PWM control signal 508 has a rising edge responsive to the T13 rising edge of the first phase PWM control signal 506 and to a fourth delay 526 provided by the delay circuit 420. The fourth delay 526 equals a quarter switching period 522 of the third switching cycle 514 because the quarter switching period 522 is less than the third delay 520 plus the delay step 524.

At time T15, the first phase PWM control signal 506 has a falling edge. At time T16, the second phase PWM control signal 508 has a falling edge responsive to the T15 falling edge of the first phase PWM control signal 506 and to the fourth delay 526.

FIG. 6 is a flow diagram for an example process 600 for adjusting a delay to be applied to second phase PWM control signals for the power converter system 100 of FIG. 1. The process 600 may be performed by one or more components of the control IC 112, such as the PWM module 170. In step 602, determine a delay timing delay_new responsive to a first phase switching frequency and a designed phase delay between the first phase and the second phase. In step 604, determine whether the absolute value of (delay_new minus delay_old) is greater than a maximum phase step phase_step. Delay_old is a delay value that was used in a most recent rising edge or falling edge of a first phase control signal. If the answer to step 604 is yes, then proceed to step 606. Otherwise, proceed to step 612.

In step 606, determine whether delay_new is greater than delay_old. If the answer to step 606 is yes, then proceed to step 608. Otherwise, proceed to step 610.

In step 608, set delay_adjusted to equal delay_old plus phase_step. In step 610, set delay_adjusted to equal delay_old minus phase_step. In step 612, set delay_adjusted to equal delay_new. After each of steps 608, 610, or 612, proceed to step 614.

In step 614, update the delay value to be applied to rising and falling edges of the second phase PWM control signal to equal delay_adjusted after the delay counter finishes counting. In step 616, control the second phase primary side switches in response to delay_adjusted and set delay_old to equal delay_adjusted. Setting delay_old to equal delay_adjusted prepares for execution of the process 600 responsive to a next switching cycle.

After step 616, the process 600 repeats from step 604, using the value of delay_new previously determined in step 602. In some examples, step 602 of the process 600 is triggered if the switching frequency of the first phase primary side switches 146 and 148 changes, or if a change in the switching frequency of the first phase primary side switches 146 and 148 exceeds a threshold.

Modifications are possible in the described examples, and other examples are possible, within the scope of the claims.

In some examples, the control circuits and processes described herein can be used to control multiple phase PWM-controlled devices other than full-bridge LLC converters, such as buck, boost, or buck-boost converters, half-bridge or full-bridge devices, DC or AC input devices, DC or AC output devices, or other devices that provide or regulate power, including across an inductor or transformer or otherwise.

In some examples, the control circuits and processes described herein can be used to control multiple phase PWM-controlled devices with more than one phase, accordingly, two or more phases.

In some examples, a designed phase delay is other than 90° (π/2 radians). In some examples, a designed phase delay for an Mth phase (integer M) of an integer N number of phases is (180/N)×(M−1) degrees or (π/N)×(M−1) radians.

In some examples, a second phase PWM control signal delay changes in a same cycle that a first phase PWM control signal switching frequency changes.

The term “couple” is used throughout the specification. The term may cover connections, communications, or signal paths that enable a functional relationship consistent with this description. For example, if device A provides a signal to control device B to perform an action, in a first example device A is coupled to device B, or in a second example device A is coupled to device B through intervening component C if intervening component C does not substantially alter the functional relationship between device A and device B such that device B is controlled by device A via the control signal provided by device A.

In this description, the term “and/or” (when used in a form such as A, B and/or C) refers to any combination or subset of A, B, C, such as: (a) A alone; (b) B alone; (c) C alone; (d) A with B; (e) A with C; (f) B with C; and (g) A with B and with C. Also, as used herein, the phrase “at least one of A or B” (or “at least one of A and B”) refers to implementations including any of: (a) at least one A; (b) at least one B; and (c) at least one A and at least one B.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin”, “ball” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors are described herein, other transistors (or equivalent devices) may be used instead with little or no change to the remaining circuitry. For example, a metal-oxide-silicon FET (“MOSFET”) (such as an n-channel MOSFET, nMOSFET, or a p-channel MOSFET, pMOSFET), a bipolar junction transistor (BJT—e.g. NPN or PNP), insulated gate bipolar transistors (IGBTs), and/or junction field effect transistor (JFET) may be used in place of or in conjunction with the devices disclosed herein. The transistors may be depletion mode devices, drain-extended devices, enhancement mode devices, natural transistors or other type of device structure transistors. Furthermore, the devices may be implemented in/over a silicon substrate (Si), a silicon carbide substrate (SiC), a gallium nitride substrate (GaN) or a gallium arsenide substrate (GaAs).

Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples may be included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. Unless otherwise stated, “about,” “approximately,” or “substantially” preceding a value means +/-10 percent of the stated value, or, if the value is zero, a reasonable range of values around zero.

What is claimed is:

1. A device comprising:
a first phase transformer including a primary winding, a secondary winding, and an isolation;
a first phase primary side circuit coupled to the primary winding of the first phase transformer;
a first phase secondary side circuit coupled to the secondary winding of the first phase transformer;
a second phase transformer including a primary winding, a secondary winding, and an isolation;
a second phase primary side circuit coupled to the primary winding of the second phase transformer;
a second phase secondary side circuit coupled to the secondary winding of the second phase transformer;
a delay circuit; and
a controller coupled to the first and second phase primary side circuits and to the delay circuit, the controller configured to:
control the first phase primary side circuit responsive to a switching cycle duration;
determine a phase delay responsive to the switching cycle duration; and
control the second phase primary side circuit, using the delay circuit, responsive to the phase delay.

2. The device of claim 1, wherein the controller is configured to:
compare the phase delay to a threshold;
adjust the phase delay responsive to the comparison to generate an adjusted phase delay; and
control the second phase primary side circuit, using the delay circuit, responsive to the adjusted phase delay.

3. The device of claim 2, wherein the threshold corresponds to a maximum change in the phase delay per switching cycle of the second phase primary side circuit.

4. The device of claim 1, further comprising:
a first capacitor coupled between a first terminal of the primary winding of the first phase transformer and a first side of the first phase primary side circuit; and
a second capacitor coupled between a first terminal of the primary winding of the second phase transformer and a first side of the second phase primary side circuit.

5. The device of claim 4, further comprising:
a first inductor coupled between a second terminal of the primary winding of the first phase transformer and a second side of the first phase primary side circuit; and
a second inductor coupled between a second terminal of the primary winding of the second phase transformer and a second side of the second phase primary side circuit.

6. The device of claim 1, further comprising a voltage sensor having first and second inputs and an output, the first input of the voltage sensor coupled between the first phase primary side circuit and the primary winding of the first phase transformer, the second input of the voltage sensor coupled between the second phase primary side circuit and the primary winding of the second phase transformer, and the output of the voltage sensor coupled to the controller.

7. The device of claim 1, wherein the device includes a number of phases greater than or equal to two, and the controller determines a phase delay for each phase other than the first phase responsive to the number of phases.

8. The device of claim 1, wherein the device is an LLC converter.

9. A device comprising:
a counter circuit configured to provide a count value;
a comparator coupled to the counter circuit and configured to:
compare the count value to a threshold; and
provide a signal based on the comparison of the count value to the threshold;
a first pulse-width modulation circuit coupled to the comparator and configured to provide a first pulse-width modulation signal having a transition based on the count value satisfying the threshold; and
a second pulse-width modulation circuit coupled to the comparator and the first pulse width modulation circuit, wherein:
the second pulse-width modulation circuit includes a delay circuit configured to determine a delay value based on the count value when the count value satisfies the threshold; and
the second pulse-width modulation circuit is configured to provide a second pulse-width modulation signal having a transition based on the transition in the first pulse-width modulation signal and the delay value.

10. The device of claim 9, wherein the delay value is based on one quarter of the count value when the count value satisfies the threshold.

11. The device of claim 9, wherein the delay circuit is configured to:
compare a change in the delay value between switching periods to a delay value step; and
limit the change in the delay value to the delay value step.

12. The device of claim 9, further comprising:
a first gate driver coupled to the first pulse-width modulation circuit; and
a second gate driver coupled to the second pulse-width modulation circuit.

13. The device of claim 12, further comprising:
first, second, third, and fourth switches each respectively having a current path and a control terminal coupled to a respective output of the first gate driver; and
fifth, sixth, seventh, and eighth switches each respectively having a current path and a control terminal coupled to a respective output of the second gate driver.

14. The device of claim 13, further comprising:
a voltage source having first and second terminals;
a first transformer including primary and secondary windings each respectively having first and second terminals, and an isolation, current paths of the fifth and sixth switches coupled to the first terminal of the secondary winding of the first transformer;
a first capacitor coupled between the second terminal of the primary winding of the first transformer at a first end and the second terminal of the voltage source and a current path of the second switch at a second end;
a first inductor coupled between the first terminal of the primary winding of the first transformer at a first end and a current path of the first switch and the current path of the second switch at a second end, and the current path of the first switch coupled between the first inductor and the first terminal of the voltage source;
a second transformer including primary and secondary windings each respectively having first and second terminals, and an isolation, current paths of the seventh and eighth switches coupled to the first terminal of the secondary winding of the first transformer;
a second capacitor coupled between the second terminal of the primary winding of the second transformer at a first end and the second terminal of the voltage source and a current path of the fourth switch at a second end; and
a second inductor coupled between the first terminal of the primary winding of the second transformer at a first end and current paths of the third and fourth switches at a second end, and the current path of the third switch coupled between the first inductor and the first terminal of the voltage source.

15. The device of claim 9, wherein the threshold corresponds to a maximum change in a phase delay per switching cycle of a second phase of a power converter controlled responsive to the second pulse-width modulation circuit, with respect to a first phase of the power converter controlled responsive to the first pulse-width modulation circuit.

16. A device comprising:
a first phase transformer including a primary winding, a secondary winding, and an isolation, the primary winding having first and second terminals;
a first phase primary side circuit that includes:
a first inductor coupled to the first terminal of the primary winding of the first phase transformer;
a first switch;
a first capacitor having first and second terminals, the first terminal of the first capacitor coupled to the second terminal of the primary winding of the first phase transformer; and
a second switch having first and second terminals, the first terminal of the second switch coupled to the first switch and the first inductor, and the second terminal of the second switch coupled to the second terminal of the first capacitor;
a first phase secondary side circuit coupled to the secondary winding of the first phase transformer;
a second phase transformer including a primary winding, a secondary winding, and an isolation;
a second phase primary side circuit that includes:
a second inductor coupled to the first terminal of the primary winding of the second phase transformer;
a third switch;
a second capacitor having first and second terminals, the first terminal of the second capacitor coupled to the second terminal of the primary winding of the second phase transformer; and
a fourth switch having first and second terminals, the first terminal of the fourth switch coupled to the third switch and the second inductor, and the second terminal of the fourth switch coupled to the second terminal of the second capacitor;
a second phase secondary side circuit coupled to the secondary winding of the second phase transformer; and
a controller coupled to the first and second phase primary side circuits, the controller configured to:
control the first phase primary side circuit responsive to a switching cycle duration;
determine a phase delay responsive to the switching cycle duration; and
control the second phase primary side circuit responsive to the phase delay.

17. The device of claim 16,
further comprising a delay circuit coupled to the controller;
wherein the controller is configured to:
compare the phase delay to a threshold;
adjust the phase delay responsive to the comparison to generate an adjusted phase delay; and
control the second phase primary side circuit, using the delay circuit, responsive to the adjusted phase delay.

18. The device of claim 17, wherein the threshold corresponds to a maximum change in the phase delay per switching cycle of the second phase primary side circuit.

19. The device of claim 16, further comprising a voltage sensor having first and second inputs and an output, the first input of the voltage sensor coupled between the first phase primary side circuit and the primary winding of the first phase transformer, the second input of the voltage sensor coupled between the second phase primary side circuit and the primary winding of the second phase transformer, and the output of the voltage sensor coupled to the controller.

20. The device of claim 16, wherein the device includes a number of phases greater than or equal to two, and the controller determines a phase delay for each phase other than the first phase responsive to the number of phases.
